(19) United States
(12) Patent Application Publication
(10) Pub. No.: US 2025/0050559 A1
(43) Pub. Date: Feb. 13, 2025

(54) METHOD FOR PRODUCING A FORK FOR A TWO-WHEELED VEHICLE

(71) Applicant: PLASTIC INNOVATION GMBH, Ottensheim (AT)

(72) Inventor: Umut CAKMAK, Mödling (AT)

(21) Appl. No.: 18/723,778

(22) PCT Filed: Jul. 3, 2023
(86) PCT No.: PCT/EP2023/068244

§ 371 Date: Jun. 24, 2024

(30) Foreign Application Priority Data
Jul. 26, 2022 (DE) 10 2022 118 736.5

(51) Int. Cl. B29C 45/17; B29L 31/30; B62K 21/02

(52) U.S. Cl. CPC B29C 45/1711; B62K 21/02; B29C 2045/1712; B29C 2045/1713; B29L 2031/3091

(57) ABSTRACT

The invention relates to a method for producing a fork which has at least one cavity in the interior and which is made of a thermoplastic for a two-wheeled vehicle by means of a plastic injection molding process and a fluid injection process, having the following steps: closing a configured injection molding tool; injecting a plasticized plastic melt into the closed injection molding tool; injecting at least one fluid into the closed injection molding tool in order to displace the plastic core out of the interior of the fork or in order to fill at least one molding cavity which is introduced into the injection molding tool; cooling the injection molded component; and opening the injection molding tool and removing the fork.

The invention relates to a method for producing a fork which has at least one cavity in the interior and which is made of a thermoplastic which is provided for a two-wheeled vehicle. A two-wheeled vehicle within the meaning of the invention can be a conventional bicycle or an electric bicycle. In addition, a two-wheeled vehicle also means a motorized two-wheeled vehicle such as a moped, motorcycle, motor scooter or electric scooter.

It is already known to manufacture components for two-wheeled vehicles from thermosetting plastics. A resin injection process known as resin transfer molding (RTM) is usually used for this purpose. In this method, glass and/or carbon fiber fabrics are inserted into a shaping tool. When the tool is closed, the fabric is impregnated with a thermosetting matrix material such as an epoxy resin or polyurethane, which is injected into the tool. The thermosetting matrix materials usually consist of two basic substances, which must be mixed well before being introduced into the tool. After mixing and injection into the tool, a chemical reaction takes place. The component can be demolded after the reactances have been implemented accordingly.

The glass or carbon fiber fabrics are usually arranged in a three-dimensionally woven state in the tool. Furthermore, an inflatable tube is inserted inside the fabric so that after the resin injection the tube inside the component can be inflated with a fluid and a cavity is created in the component. Once the reaction of the reactants is complete, the pressurized fluid is drained. The cured component can then be removed.

The production of such components from thermosetting matrix material is not only associated with relatively high manufacturing costs, but also with the major disadvantage that thermosetting materials cannot be properly recycled. Apart from thermal recycling by incineration, i.e., as an energy source, there is no effective way to recycle plastic components made from thermosetting matrix material.

The aforementioned disadvantages could be remedied by using a plastic with thermoplastic material properties. It is generally known that thermoplastics can be melted, reshaped and molded several times.

Due to the unfavorable material properties (creep behavior, strength values are dependent on time and temperature) with regard to the required stability that a fork must have for a two-wheeled vehicle, a pure rib construction made entirely of thermoplastic does not have the required torsional and bending stiffness. After all, the wheel fork is a safety-relevant component where failure due to material fatigue or a sudden fall can sometimes result in serious injury or even death. Two-wheel forks must therefore be able to withstand high forces from vertical and horizontal forces, for example when riding over a bump. For example, the forces acting on a front fork can be up to 780 newtons, in particular in extreme situations such as when riding out of the saddle, through potholes or during emergency braking.

Based on the disadvantages outlined above, the object of the present invention is therefore to provide a reliable method by which a two-wheel fork can be manufactured entirely from a thermoplastic material which fulfills safety-relevant requirements and is easily recyclable.

According to the invention, this object is achieved by a method for producing a fork (tubular geometry) which has at least one cavity in the interior and which is made of a thermoplastic for a two-wheeled vehicle by means of a plastic injection molding process and a fluid injection process according to the features of claim 1, wherein preferred embodiments are the subject matter of the sub-claims.

To this end, the method according to claim 1 advantageously proceeds as follows:
closing a configured injection molding tool;
injecting a plasticized plastic melt into the closed injection molding tool via at least one injection point AS;
injecting at least one fluid into the closed injection molding tool in order to displace the plastic core out of the interior of the fork or in order to fill at least one molding cavity which is introduced into the injection molding tool via at least one injection point AF;
cooling the injection molded component; and
opening the injection molding tool and removing the finished fork.

Optionally, it would be conceivable to modify the sequence of steps of the method according to the invention accordingly by the following steps:
optionally only a short holding pressure time of approx. two seconds after injection of the plasticized plastic melt;
optionally maintaining the fluid pressure for a short time inside the fork to be finished (holding pressure);
optionally flushing the inside of the fork using the same fluid or a different fluid to achieve a better cooling effect;
optionally blowing out of the fluid or suctioning by vacuum.

The fluid used is generally water or gas. However, it can also consist of both media, as an air bubble is often pushed in front of the water, for example, or wherein nitrogen is first used to form the cavity and then CO₂ is used to cool the finished component.

In the method according to the invention, a cavity of the closed injection molding tool forms the geometry of the subsequent component, wherein a wheel fork for a two-wheeled vehicle is provided according to the invention. The injection molding tool is equipped with at least one injector for the introduction of a fluid. The fluid displaces the plastic core from the inside of the fork, forming a cavity that has a tubular cross-section, for example. It is also possible for the fluid to be injected via a preset profile under volume flow or pressure/time control. Thanks to the tubular cross-section, the cooling phase of the hot plastic melt can be considerably shortened due to the comparatively thin remaining wall thickness. This means that only a comparatively short cooling time is required.

Overall, the method according to the invention is characterized by a very significant reduction in cooling time compared to methods for manufacturing components from solid material. Due to the advantageous reduction in cooling time, the process time for manufacturing a two-wheel fork can be significantly reduced, which makes it possible to manufacture a two-wheel fork using the method according to the invention more cost-effectively overall compared to conventional manufacturing methods. In addition, the cavity inside the fork reduces the mass of the two-wheeled vehicle, which not only provides a weight advantage, but also an economic advantage in particular. Furthermore, a closed tubular fork cross-section also results in greater rigidity. When we talk about a tubular cross-section here, it can of course be circular, oval, polygonal or any other shape.

Advantageous embodiments of the invention result from the sub-claims following the main claim.

Accordingly, in an advantageous embodiment of the method according to the invention, it is provided that the fork is produced from at least one reinforced and/or unreinforced thermoplastic. Accordingly, a plastic selected from the following group is used in the method according to the invention: polyamide, preferably polyamide 12, polyamide 6 or polyamide 6.6, polypropylene, polyethylene, polyethersulfone, polyetherimide, polyetherketone, polyphenylene sulfide, polyvinyl chloride, polyester, acrylonitrile-butadiene-styrene (ABS), polycarbonate/acrylonitrile-butadiene-styrene (ABC/PC), polycarbonate (PC), polyethylene terephthalate (PET) and particularly preferably polybutylene terephthalate [or]. These plastics can be selected and used individually or in combination with one another. The selected plastics can also be reinforced with short and/or long fibers made of glass, carbon and/or natural fibers. Alternatively, the plastic can also be injected into the injection molding tool as caprolactam with an associated activator and polymerized in the heated tool. The fork made of the thermoplastic matrix material can be easily recycled and is therefore recyclable.

Furthermore, in an alternative variant of the method according to the invention, it may be provided that the fork is additionally reinforced by means of unidirectional tapes and/or organosheets (design and/or functional film and/or tape made of carbon or glass fiber fabric) arranged in the injection molding tool, wherein a material-locking bond is formed with the thermoplastic melt.

According to another possible embodiment of the invention, at least one overflow cavity can be provided in the injection molding tool for cavity formation, into which at least one fluid volume flow of the injected fluid presses the plastic core.

According to a variant of the method according to the invention, it is provided that the fork is produced by the melt push-back process, wherein the at least one fluid volume flow of the injected fluid displaces the plastic core through a channel back to in front of the screw of the injection molding machine, and wherein the fluid is injected on the side of the fork opposite to the corresponding injection point of the melt.

According to another advantageous embodiment of the method according to the invention, the at least one shaping cavity introduced into the injection molding tool is only partially filled with the thermoplastic melt and the plastic core is displaced by the at least one fluid volume flow of the injected fluid to form a cavity, wherein the plastic melt is inflated for displacement in such a way that it lies against the wall of the injection molding tool. Nevertheless, the injected fluid ensures complete residual filling of the cavity arranged in the injection molding tool. Blowing up the melt in turn enables very economical use of the thermoplastic available for the production of the fork.

Alternatively, it can be provided that the fluid injected into the fork pushes a projectile arranged on an injector in front of it, wherein the projectile produces an inner diameter which is constant over a certain length of the fork.

In addition to a first shaping component cavity in the injection mold, which is preferably interchangeable, additional shaping component cavities can be used to produce any component geometry.

According to another advantageous embodiment of the invention, an additional tubular insert to be overmolded is inserted into a region of the injection molding tool forming a fork shank. In this way, the strength in the shank region of the fork can be significantly increased once again.

Furthermore, the fork shank can be reinforced by placing unidirectional tapes and/or organosheets partially or over a large area on the insert before the plastic melt is injected, so that a material bond is created with the thermoplastic melt. In order to achieve the best possible bond between the tapes and the thermoplastic melt, it is particularly advantageous to preheat the tapes and/or organosheets to a specific temperature before inserting them into the mold, wherein this specific temperature is selected depending on the matrix material of the tape.

It would also be conceivable for the tapes and/or organosheets to be placed and held in the mold by a special device, for example. By aligning the fibers of the tapes and/or organosheets in a targeted manner, the stiffness can be increased, particularly in critical areas of the component.

Alternatively, it can also be provided that the insert is made from the same thermoplastic as the rest of the fork.

In another advantageous embodiment of the method according to the invention, grooves, elevations and/or specific contours are formed on the inner wall of the insert, as a result of which a material-locking connection with increased stiffness and damage tolerance is produced between the insert and the plastic melt when the plastic melt is injected.

Alternatively, according to another variant of the method according to the invention, it can be provided that at least one through-flow channel is provided on the underside of the insert, through which the plastic melt flows into the interior of the insert, wherein the at least one through-flow channel is formed on the longitudinal side of the insert.

Yet another advantageous embodiment of the invention provided that the insert and the injection molding tool optionally each have at least one positioning aid.

According to an alternative embodiment of the method, it is provided that at least one metallic component to be integrated and/or one non-metallic component, such as pultruded braided or wound fiber elements, is inserted individually or in groups into the cavity of the injection molding tool and back-molded and/or overmolded with the plastic melt.

Preferably, at least one component to be integrated is a threaded sleeve, a screw-in sleeve, an insert, a stiffening element, a brake mount, a brake caliper mount and/or the like.

According to another advantageous embodiment, the fork has at least two interfaces which are each provided for fixing corresponding wheel mounts, wherein the wheel mounts are preferably plugged in. This makes it quick and easy to replace the wheel mounts, as no screws, bolts or other comparable connecting elements, which would also require a suitable tool, need to be attached or detached. On the other hand, the sophisticated interfaces enable the connection of a corresponding wheel, so that the fork is suitable for a variety of different wheels.

According to yet another advantageous embodiment of the method according to the invention, it is provided that at least one recess, a pocket, a groove and/or other elements for lighting and/or signaling means to be integrated, such as indicators and/or disc brake mounts and/or for forming a cable duct, are co-molded on the fork. The means to be integrated can, for example, be fitted into the recess provided during final assembly of the bicycle.

It would also be conceivable that the fork has a defined interface for the form-fitting attachment of a handlebar stem, wherein the interface is suitable for receiving various handlebar stems.

Finally, the invention relates to a fork made of thermoplastic for a two-wheeled vehicle which is produced according to one of the aforementioned embodiments of the method according to the invention. According to an alternative embodiment, it can also be provided that at least one interface for electronic signal transmission corresponding to a bicycle frame is provided on the fork. In this context, it should not go unmentioned that the fork made of a thermoplastic, which is electrically non-conductive if no carbon fiber reinforcement is used, enables interference-free signal, data and/or energy transmission. Additional cabling to conduct the energy produced from an energy-generating unit such as a dynamo to the consumer, for example a bicycle light, could also be realized by means of an appropriately designed foil in the cavity of the fork.

Further details and advantages of the invention result from the following exemplary embodiments shown with the help of the figures.

In the figures:

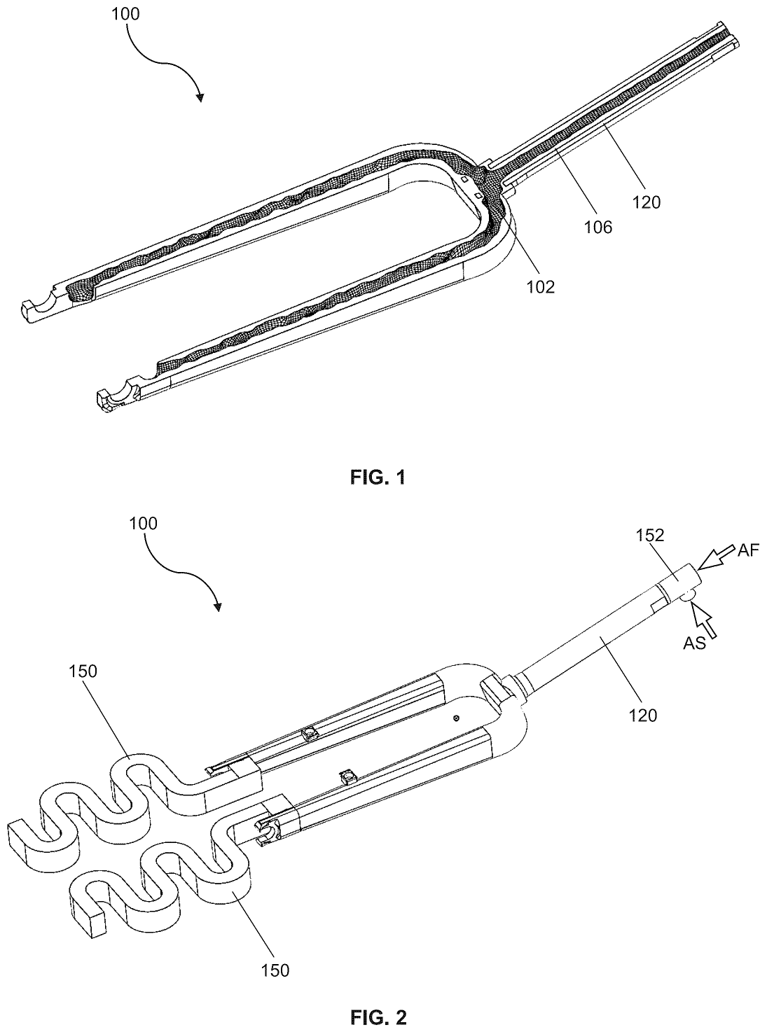

FIG. 1 shows a section through a fork produced by means of the method according to the invention;

FIG. 2 shows the fork with an overflow cavity and injection points;

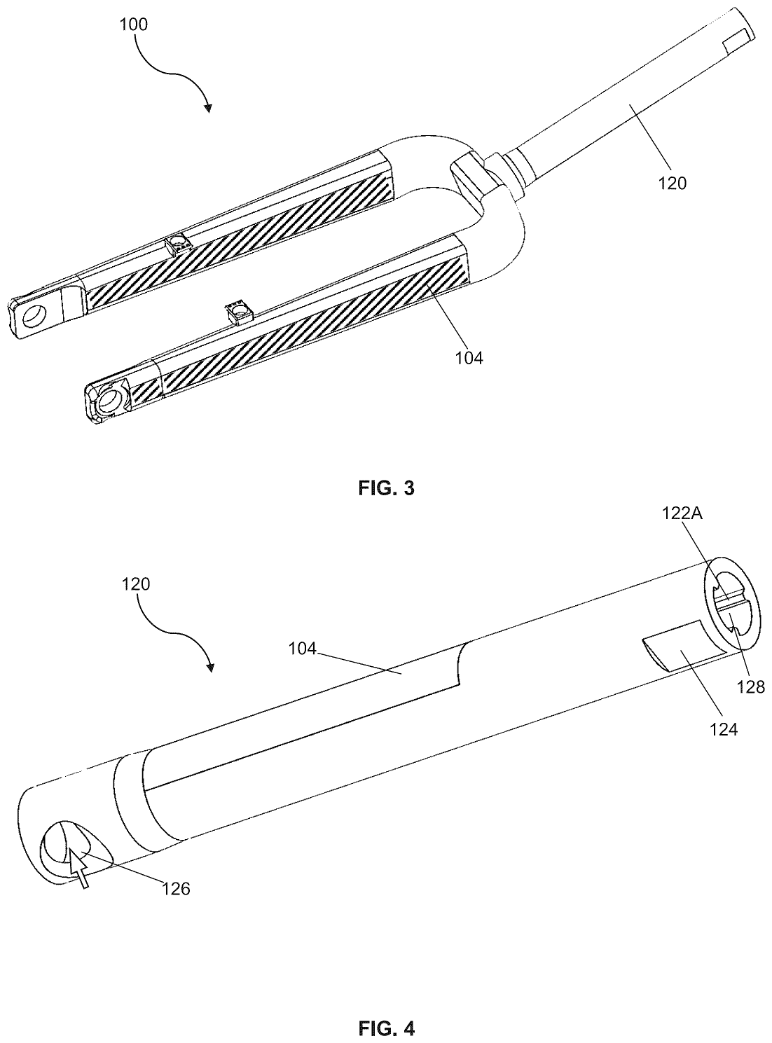

FIG. 3 shows the fork with additional unidirectional tapes or organosheets;

FIG. 4 shows the insert;

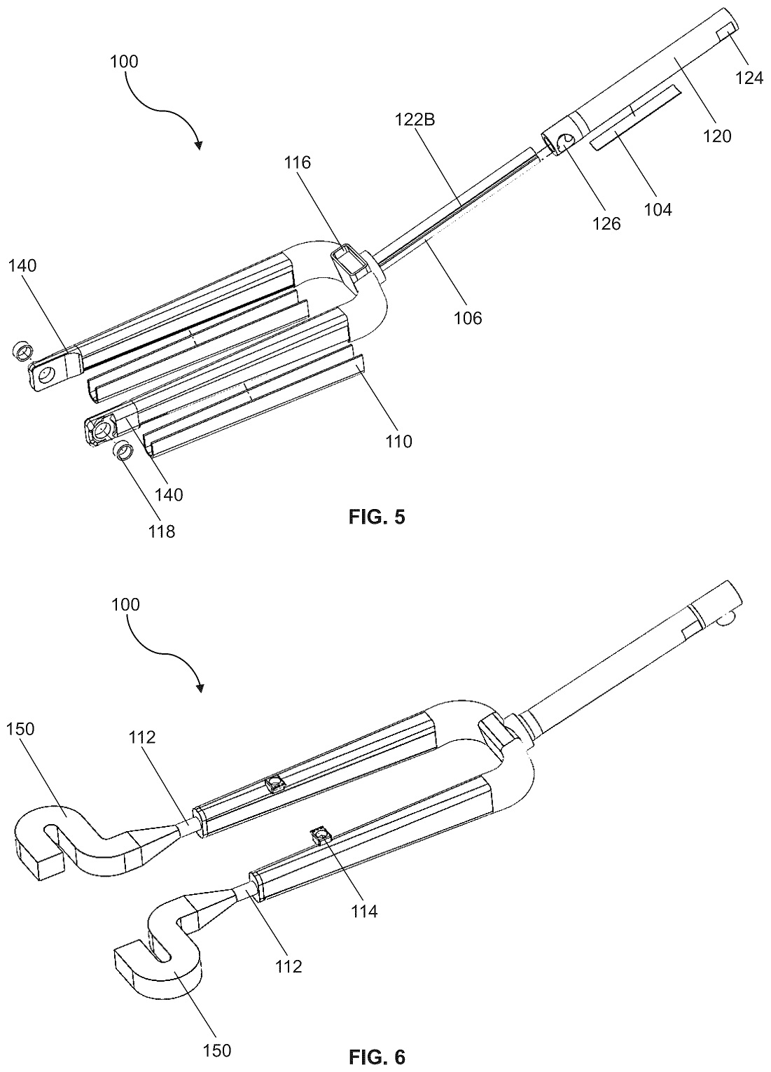

FIG. 5 shows an exploded view of a fork produced by means of the method according to the invention;

FIG. 6 shows an alternative design of a fork produced by means of the method according to the invention with an overflow cavity.

In the exemplary embodiments according to FIGS. 1 to 6, possible embodiments of the fork, which were produced using the method according to the invention or using a variant of the method, are considered in more detail.

In general, the plastic core can be displaced from the component in different ways. One form of performing the method, for example, would be mass recompression. Another form would be to blow out the material of the plastic core into an overflow cavity.

Furthermore, an inflation process can also be provided in which a smaller amount of thermoplastic is injected into the injection molding tool, which is then inflated. The amount of plastic injected is selected such that almost no material is displaced from the injection molding tool during inflation.

FIG. 1 shows a schematic sectional view of the fork 100, which has been produced by means of the method according to the invention. Furthermore, the sectional view in FIG. 1 shows the cavity 102 formed inside the fork and the insert 120 reinforcing the fork shank 106. The insert is usually inserted and positioned in the tool when configuring the injection molding tool. As further shown, the inner wall of the cavity 106 formed in the fork 100 does not have a smooth surface, but rather a large number of raised and recessed areas. The closed tool in which the fork 100 shown is produced is not shown in detail.

FIG. 2 shows the fork 100 from FIG. 1 in its entirety. The overflow cavities 150, which are arranged in the area of the wheel mounts when configuring the tool, and the injection element 152, which is also inserted into the injection molding tool and comprises the injection points AF and AS, can also be seen.

At the injection point AS, which may be located at the upper end of the fork shank 106 of the closed injection molding tool, a plasticized plastic melt is injected in the direction of the arrow shown according to the invention, while at the injection point AF, after injection of the plastic melt, the fluid is injected in the direction of the arrow of the corresponding arrow by an injector (not shown in detail here), such that the so-called plastic core is displaced from the interior of the fork 100 into the overflow cavities 150.

As soon as the fluid injection and the associated displacement of the excess plastic material from the fork 100 is complete, the overflow cavities 150 can be closed hydraulically, pneumatically and/or electrically, preferably via a slide valve (not shown in detail).

In general, the tools inserted into the injection molding tool (not shown in detail) represent shaping cavities. Using these shaping cavities (not shown in detail) it is possible to produce large numbers of hollow-walled forks with a specific shape inside the fork. Furthermore, the at least one shaping cavity can be interchangeable in order to produce any component geometry by means of additional shaping cavities.

As shown in FIG. 3, unidirectional tapes and/or organosheets 104 can be inserted into certain areas of the injection molding tool to reinforce the fork 100 to be manufactured. By aligning the fibers of the tapes and/or organosheets 104 in a targeted manner, the stiffness can also be adjusted, particularly in critical areas of the fork.

In addition to the aforementioned unidirectional tapes and/or organosheets 104, the illustration according to FIG. 3 also shows the tubular insert 120 overmolded in the region of the fork shank 106. The insert 120 can also be made of thermoplastic. According to an alternative embodiment of the method according to the invention, the insert 120 is even made from the same thermoplastic as the rest of the fork 100. Aluminum and/or steel inserts are also conceivable.

FIG. 4 shows a detailed view of the insert 120. In the upper region of the insert 120, i.e., where the handlebar of the two-wheeled vehicle is to be attached, the trapezoidal contours 122A formed on the inner wall can be seen, wherein the contours 122A can also be grooves, depressions, elevations and/or any other pattern. In this way, when the plastic melt is injected, a material-locking connection with increased strength is created between the insert 120 and the overmolded plastic, producing a high-strength fork shank 106 overall.

As can also be seen, in addition to the inlet 128, at least one through-flow channel 126 can be provided on the underside of the insert 120, through which the injected plastic melt flows into the interior of the insert 120, wherein the at least one through-flow channel 126 is formed on the longitudinal side of the insert 120. The arrow shown in FIG. 4 points in the flow direction of the plastic melt flowing into the insert 120.

Furthermore, an exemplary positioning aid 124 is located in the upper region of the insert 120, which is intended to improve the handling of the insert 120 and its positioning in the injection mold. A positioning aid adapted to a gripper is particularly advantageous, wherein such a corresponding gripper is controlled by a robot. In this way, the speed of the robot used for parts handling can be increased, such that the cycle time for producing the fork 100 can be reduced. At the same time, the failure rate when handling the parts is reduced. In addition to positioning aids 124 on the insert 120, positioning aids can also be provided in the injection molding tool.

FIG. 5 shows an exploded view of a fork 100 produced by means of the method according to the invention. The contour 122B corresponding to the contour 122A, which is formed along the fork shank 106 and represents a material-locking connection with the insert 120, is particularly easy to recognize.

Furthermore, at least one raised pocket 116 and/or recessed pocket for holding elements such as light guides, headlights, indicators and/or similar elements may be integrated into the fork 100. According to the method according to the invention at least one recess, a pocket a groove and/or other elements for lighting and/or signaling means to be integrated, such as indicators and/or disc brake mounts and/or for forming a cable duct, can also be co-molded on the fork 100.

At this point, it should not go unmentioned that the cavity 102 in the fork 100 can also be provided as a cable guide in order to establish a connection between the handlebars, the frame and/or electronic devices integrated in the fork with other electronic devices attached to the two-wheeled vehicle. It would also be particularly advantageous if the cables running in the cavity 102 of the fork 100 were routed directly into a hollow-walled handlebar stem and/or into the frame of the two-wheeled vehicle by means of a cable guide. Alternatively, the cavity 102 of the fork 100 can also be used as a guide for brake and/or shift cables. The routing of hydraulic brake lines or similar would also be conceivable here.

The components integrated into the fork 100 can also be threaded sleeves 118, screw-in sleeves, inserts, stiffening elements 110, brake mounts, the brake caliper mounts 114 shown in FIG. 6 and/or the like. The threaded sleeves 118 are integrated into the wheel holders 140 in the illustration shown in FIG. 5.

In order to further increase the strength/rigidity of the fork shank, unidirectional tapes and/or organosheets 104 can be inserted into the injection molding tool in regions of the insert 120 before the plastic melt is injected according to an alternative variant of the method according to the invention and then back-injected. By arranging the unidirectional tapes and/or organosheets 104 on the insert 120, the strength/rigidity of the insert or the fork shank can be further increased.

FIG. 6 shows a fork 100 produced using the method according to the invention, which has two interfaces 112, each of which is provided for fixing corresponding wheel mounts 140. Preferably, the interfaces 112 enable the wheel holders 140 to be simply plugged in. Because the wheel mounts 140 can be plugged in, they can be replaced easily and flexibly. Consequently, this plug-in principle proves to be advantageous in the event of damage to a wheel mount 140. The overflow cavities 150, shaping openings of which can be decisive with regard to the shaping of the interfaces 112, are also significant. Nevertheless, the plastic melt displaced from the fork 100 can flow into the overflow cavities 150.

All in all, the present invention represents an excellent solution with regard to the manufacture of thermoplastic components for two-wheeled vehicles.

### LIST OF REFERENCE NUMERALS

100 Fork
102 Cavity
104 Unidirectional tapes or organosheets
106 Fork shank
110 Stiffening element
112 Interface for wheel mounts
114 Brake caliper mount
116 Pocket
118 Threaded sleeve
120 Insert
122A Contour in the insert
122B Contour in the plastic
124 Positioning aid
126 Through-flow channel
128 Inlet
140 Wheel mount
150 Overflow cavity
152 Injection element
AS Injection point fluid
AF Injection point melt

1. Method for producing a fork which has at least one cavity in the interior and which is made of a thermoplastic for a two-wheeled vehicle by means of a plastic injection molding process and a fluid injection process, comprising the following steps:
closing a configured injection molding tool;
injecting a plasticized plastic melt into the closed injection molding tool via at least one injection point AS;
injecting at least one fluid into the closed injection molding tool in order to displace the plastic core out of the interior of the fork or in order to fill at least one molding cavity which is introduced into the injection molding tool via at least one injection point AF;
cooling the injection molded component; and
opening the injection molding tool and removing the fork.

2. Method according to claim 1, wherein the fork is made of at least one reinforced and/or unreinforced thermoplastic.

3. Method according to claim 1, wherein the fork is additionally reinforced by means of unidirectional tapes and/or organosheets arranged in the injection molding tool.

4. Method according to claim 1, wherein at least one overflow cavity is provided in the injection molding tool for cavity formation, into which at least one fluid volume flow of the injected fluid presses the plastic core.

5. Method according to claim 1, wherein the at least one fluid volume flow of the injected fluid presses the plastic core back into the space in front of the screw of the injection molding machine to form a cavity.

6. Method according to claim 1, wherein the cavity arranged in the injection molding tool is partially filled with the plastic melt and the plastic core for cavity formation is displaced by the at least one fluid volume flow of the injected fluid, wherein for displacement, the plastic melt is inflated in such a way that it adheres to the wall of the injection molding tool, and wherein the injected fluid ensures the residual filling of the cavity arranged in the injection molding tool.

7. Method according to claim 1, wherein the fluid injected into the fork pushes a projectile arranged on an injector in front of it, wherein the projectile produces an inner diameter which is constant over a certain length of the fork.

8. Method according to claim 1, wherein an additional tubular insert to be overmolded is inserted into a region of the injection molding tool forming a fork shank.

9. Method according to claim 8, wherein unidirectional tapes and/or organosheets are arranged partially or over a large area on the insert to reinforce the fork shank before the plastic melt is injected.

10. Method according to claim 8, wherein the insert is made from the same thermoplastic as the rest of the fork.

11. Method according to claim 8, wherein grooves, elevations and/or specific contours are formed on the inner wall of the insert, as a result of which a material-locking connection with increased strength is produced between the insert and the plastic melt when the plastic melt is injected.

12. Method according to claim 8, wherein at least one through-flow channel is provided on the underside of the insert, through which the plastic melt flows into the interior of the insert, wherein the at least one through-flow channel is formed on the longitudinal side of the insert.

13. Method according to claim 8, wherein the insert and the injection molding tool optionally each have at least one positioning aid.

14. Method according to claim 1, wherein at least one metallic component to be integrated and/or one non-metallic component is inserted individually or in groups into the cavity of the injection molding tool and back-molded and/or overmolded with the plastic melt.

15. Method according to claim 14, wherein at least one component to be integrated is a threaded sleeve, a screw-in sleeve, an insert, a stiffening element, a brake mount, and/or a brake caliper mount.

16. Method according to claim 1, wherein the fork has at least two interfaces which are each provided for fixing corresponding wheel mounts.

17. Method according to claim 1, wherein at least one recess, a pocket, a groove and/or other elements for lighting and/or signaling means to be integrated are co-molded on the fork.

18. Method according to claim 1, wherein the fork has a defined interface for the form-fitting attachment of a handlebar stem, wherein the interface is suitable for receiving various handlebar stems.

19. Fork made of thermoplastic for a two-wheeled vehicle, wherein the fork is produced using the method according to claim 1.

20. Fork according to claim 19, wherein at least one interface for electronic signal transmission corresponding to a bicycle frame is provided on the fork.
